(19) United States
(12) Patent Application Publication
(10) Pub. No.: US 2009/0234726 A1
(43) Pub. Date: Sep. 17, 2009

(54) AUTOMOBILE LOCATION BASED ADVERTISING

(75) Inventor: VAIBHAV BHANDARI, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/047,074

(22) Filed: Mar. 12, 2008

(51) Int. Cl. G06Q 30/00

(52) U.S. Cl. 705/14

(57) ABSTRACT

In accordance with embodiments of the present invention, systems and methods for providing targeted advertising content to a user in an automobile based on location are provided. More specifically, a computing device within the automobile receives advertising content from endpoints at various locations. The advertising content received may be an audio advertisement, a displayed advertisement presented on a display device associated with the computer, etc. Further, the advertising content may be from an entity associated with the endpoint, or may be from an entity not associated with the endpoint, that has dealt directly with the other entity in providing advertising content to the user.

### BACKGROUND

Advertising to an individual in an automobile typically is achieved through audio advertisements. Audio advertisements, such as those played over the radio, are centralized advertisements transmitted to every listener within the signal of the radio station, regardless of the location of the individual.

### SUMMARY

In accordance with embodiments of the present invention, systems and methods for providing targeted advertising content to a user in an automobile based on location is provided. More specifically, a computer within the automobile receives advertising content from endpoints at various locations. The advertising content received may be an audio advertisement, a displayed advertisement presented on a display device associated with the computer, etc. Further, the advertising content may be from an entity associated with the endpoint, or may be from an entity not associated with the endpoint, that has dealt directly with the other entity in providing advertising content to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of a computing system environment suitable for use in implementing the present invention;

FIG. 2 is a block diagram illustrating an overview of a system in accordance with an embodiment of the invention;

FIG. 3 is a flow diagram illustrating a method in accordance with an embodiment of the invention; and

FIG. 4 is a flow diagram illustrating a method in accordance with an embodiment of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In accordance with embodiments of the present invention, a computer storage media having computer-executable instructions embodied thereon for performing a method for providing targeted advertising content to a user in an automobile based on the location of the automobile is provided. The method comprises, in part, locating an endpoint, where the endpoint is associated with the location of the automobile over a network; receiving advertising content from the endpoint; and providing the advertising content to the user in the automobile.

In another embodiment of the present invention, a computer system for providing targeted advertising to a user in an automobile is provided. The system comprises, in part, a receiving component configured to receive advertising content from an endpoint; and a presenting component configured to present the received advertising content.

In yet another embodiment of the present invention, a computer storage media having computer-executable instructions embodied thereon for performing a method for providing targeted advertising content to a user in an automobile based on the location of the automobile, where the automobile is connected to an endpoint over a network, is provided. The method comprises, in part, identifying the automobile over the network; and sending advertising content from the endpoint to the automobile, where the endpoint is associated with the location of the automobile.

Having briefly described an embodiment of the present invention, an exemplary operating environment for the present invention is described below.

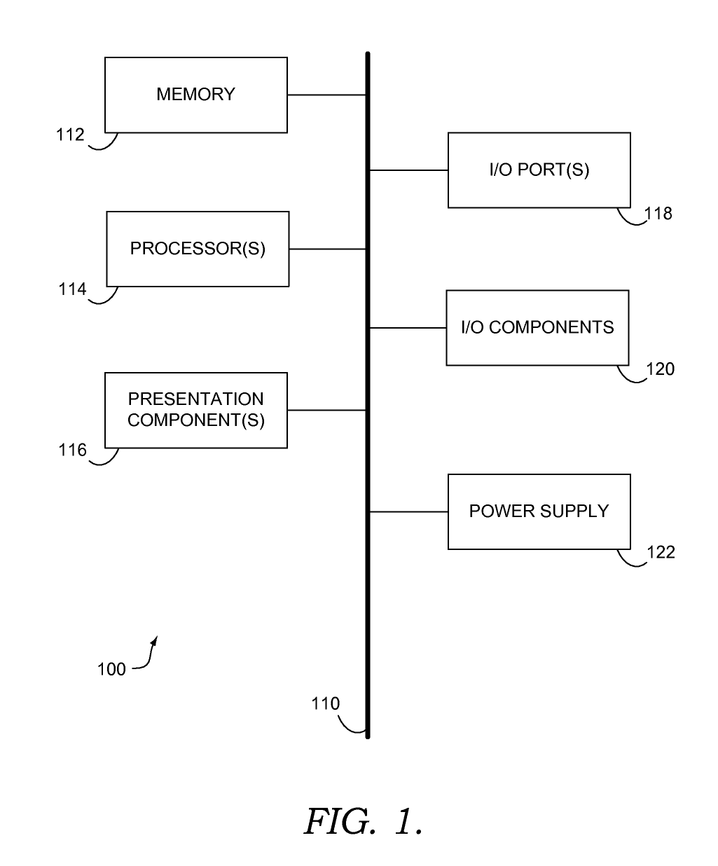

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

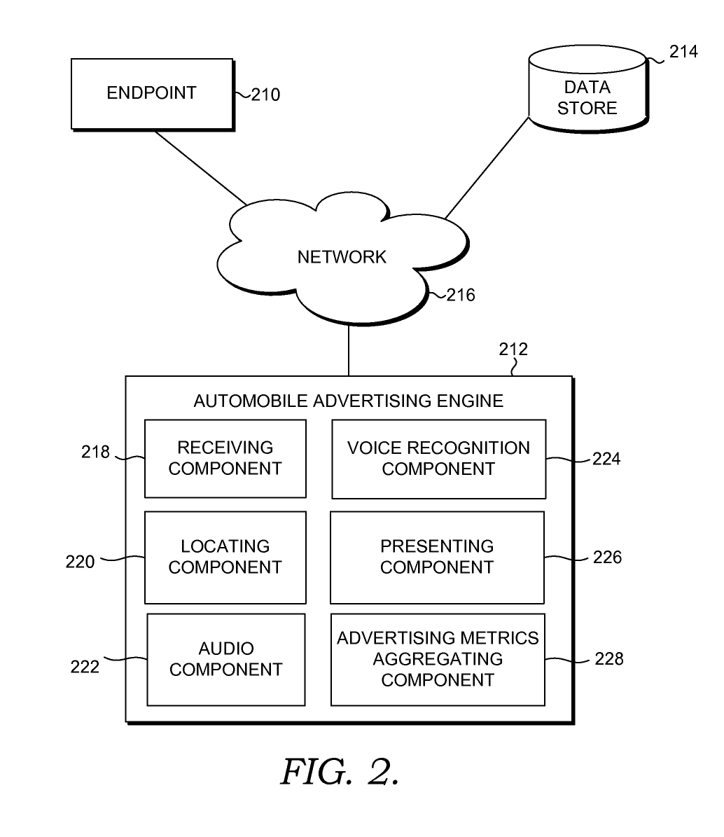

Turning now to FIG. 2, a block diagram is illustrated that shows an exemplary computing system 200 configured to provide targeted advertising, in accordance with an embodiment of the present invention. It will be understood and appreciated by those of ordinary skill in the art that the computing system 200 shown in FIG. 2 is merely an example of one suitable computing environment and is not intended to suggest any limitation as to the scope of use or functionality of the present invention. Neither should the computing system 200 be interpreted as having any dependency or requirement related to any single component/module or combination of components/modules illustrated therein.

Computing system 200 includes an automobile advertising engine 212, an endpoint 210, and a data store 214 all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The data store 214 may be configured to store information associated with various types of content, as more fully described below. It will be understood and appreciated by those of ordinary skill in the art that the information stored in the data store 214 may be configurable and may include any information relevant to advertising content. Further, though illustrated as a single, independent component, data store 214 may, in fact, be a plurality of data stores, for instance, a database cluster, portions of which may reside on a computing device associated with the automobile advertising engine 212, the endpoint 210, another external computing device (not shown), and/or any combination thereof.

Each of the automobile advertising engine 212 and the endpoint 210 shown in FIG. 2 may be any type of computing device, such as, for example, computing device 100 described above with reference to FIG. 1. By way of example only and not limitation, the automobile advertising engine 212 and/or the endpoint 210 may be a personal computer, desktop computer, laptop computer, handheld device, mobile handset, consumer electronic device, and the like. More specifically, the automobile advertising engine 212 may be any type of computing device in operation within an automobile. It should be noted, however, that the present invention is not limited to implementation on such computing devices, but may be implemented on any of a variety of different types of computing devices within the scope of the embodiments hereof.

In regards to endpoint 210, this invention contemplates a plurality of endpoints, such as endpoint 210 that may interact with the automobile advertising engine 212 through a network, such as network 216. Each endpoint may be located in any possible location where an automobile may be within the proximity to send and/or receive content to or from the endpoint. For example, an endpoint may exist at a gas station, coffee shop, or fast-food restaurant.

As shown in FIG. 2, the location connecting engine 212 includes a receiving component 218, a locating component 220, an audio component 222, a voice recognition component 224, a presenting component 226, and an advertising metrics aggregating component 228. In some embodiments, one or more of the illustrated components 218, 220, 222, 224, 226, and 228 may be implemented as stand-alone applications. In other embodiments, one or more of the illustrated components 218, 220, 222, 224, 226, and 228 may be integrated directly into the operating system of the automobile advertising engine 212. In the instance of multiple servers, embodiments of the present invention contemplate providing a load balancer to federate incoming queries to the servers. It will be understood by those of ordinary skill in the art that the components 218, 220, 222, 224, 226, and 228 illustrated in FIG. 2 are exemplary in nature and in number and should not be construed as limiting. Any number of components may be employed to achieve the desired functionality within the scope of the embodiments of the present invention.

Receiving component 218 is configured to receive content from an endpoint, such as endpoint 210 in FIG. 2. More specifically, receiving component 218 may receive advertising content from the endpoint. As discussed above, endpoint 210 may be any endpoint that is transmitting advertising content, and which the automobile advertising engine 212 may reach via network 216. Once received by the receiving component 218, the content may be stored, for instance, in association with data store 214, such that it is searchable to determine satisfaction of a user query, as more fully described below. Such received content may additionally be indexed, if desired.

As discussed above, each endpoint may be associated with an entity, such as a gas station, a coffee shop, a restaurant, and the like. In some embodiments, the advertising content received from the endpoint may be directly associated with the entity. In other words, if the endpoint is associated with a gas station, the advertising content may include advertisements, coupons, etc. for the gas station. Additionally, the advertising content received from the endpoint may be associated with a different entity. So, in the above example, the user may receive an advertisement for a clothing store, while located at the gas station. In such embodiments, the entity that is not associated with the endpoint will deal directly with the entity associated with the endpoint in providing advertising content. This decentralized method of advertising allows the entity associated with the endpoint to determine which advertising content is received by the user in an automobile. For this example, the entity not associated with the endpoint (e.g., the clothing store) would most likely be proximately located to the entity that is associated with the endpoint (e.g., the gas station).

Locating component 220 is configured to locate endpoints that may be associated with the location of the automobile advertising engine 212, or, in other words, with the location of the automobile. Likewise, the endpoints, such as endpoint 210, may be able to locate the automobile. One skilled in the art will understand and appreciate that any suitable method may be used by the locating component 220 to locate endpoints. One will further appreciate that the method may depend upon the type of network (e.g., network 216) that is used to connect the automobile advertising engine 212 to the endpoint 210.

Audio component 222 is configured to provide audio to a user within the automobile. More specifically, the audio component 222 provides a method of presenting the received advertising content (e.g., from receiving component 218) to the user, for example, in the form of an audio advertisement. In one embodiment, when an audio advertisement has been received by the automobile advertising engine 212, it may be provided to the user by playing the audio advertisement in a predetermined ad space, similar to ad space provided by cable television. These ad spaces, or skip spaces, are not assigned to a standard radio advertisement, and could then receive a targeted, decentralized advertisement from the nearest located endpoint.

Voice recognition component 224 is configured to recognize voice input provided by the user in the automobile. Voice input may then be used to control the various components or functions of the automobile advertising engine 212, such as by responding to a received advertisement. In one embodiment, a user may receive advertising content from an endpoint, and may then be asked to provide a response or to make a selection from the provided content. One skilled in the art will understand and appreciate that any method of voice recognition is contemplated to be within the scope of this invention.

Presenting component 226 is configured to present the received advertising content. Typically such presentation will be by way of display in association with a user interface. However, other forms of presentation, including audio/video presentation, are contemplated to be within the scope of embodiments hereof. In some embodiments, an automobile may be equipped with a display device for use with another aspect of the automobile, for example, a device that displays global positioning information. The present invention may use such a display device to present received advertising content.

Advertising metrics aggregating component 228 is configured to aggregate metrics associated with the automobile advertising engine 212. One skilled in the art will appreciate that such metrics will be advertisement domain dependent. For example, metrics that may be aggregated include impressions, ad plays, markets, etc. The advertising metrics may be aggregated at the endpoint, thereby providing the information to the entity providing the advertisements at the endpoint.

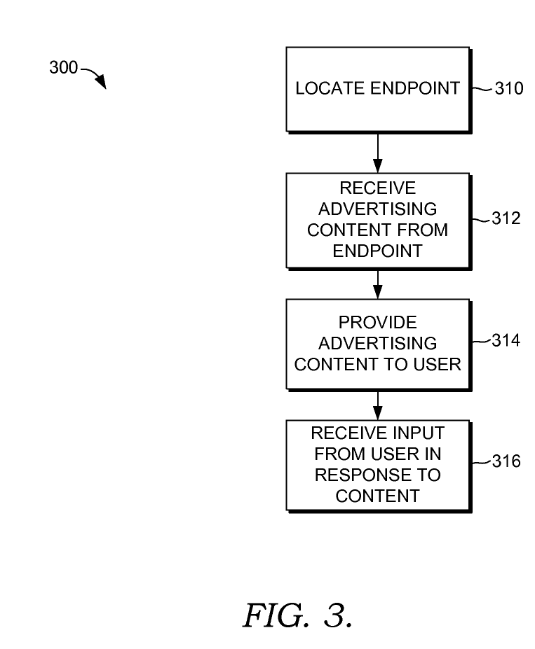

Turning now to FIG. 3, an exemplary method 300 for providing targeted advertising to a user is illustrated. Initially, as indicated in block 310, the endpoint from which the automobile will receive advertising content is located (e.g., by utilizing the locating component 220 of FIG. 2). The endpoint may be located over a network, if both the endpoint and the automobile system are both present on the same network. After an endpoint has been located, the automobile received advertising content, as indicated at block 312, for example, by utilizing receiving component 218 in FIG. 2. The advertising content may comprise any advertising content suitable for the automobile to receive, and may include audio advertisements, display advertisements, etc.

Next, at block 314, the received advertising content is provided to the user in the automobile. The advertising content is provided using any suitable method known in the art. Exemplary methods of providing advertising content may include playing an audio advertisement (e.g., by using audio component 222 in FIG. 2), or presenting an advertisement to the user on a display device (e.g., by using presenting component 226 in FIG. 2).

In some embodiments, the advertising content provided to the user may request some type of response from the user. If so, the user may provide input, as is indicated at block 316 (e.g., by utilizing the voice recognition component 224 in FIG. 2). Input may be received in any suitable method, as will be appreciated by one skilled in the art. For example, if the automobile system includes a display device and the display device is touch-sensitive, the user may provide input by touching the screen of the display device.

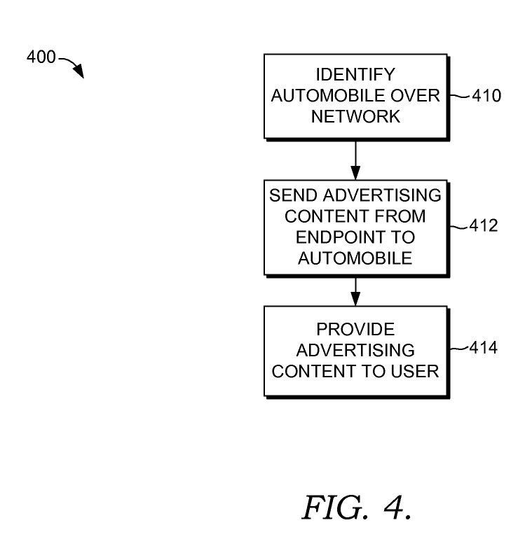

Turning now to FIG. 4, an exemplary method 400 for providing targeted advertising to a user is illustrated. Initially, as indicated in block 410, the endpoint identifies the automobile on the same network as the endpoint. As mentioned above, the endpoint and the automobile may be connected over any type of network, as would be appreciated by one skilled in the art. Next, at block 412, the endpoint sends advertising content to the automobile. Finally, as discussed above, the advertising content may be provided to the user in the appropriate manner given the type of advertising content received. This is indicated at block 414.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. One or more computer storage media having computer-executable instructions embodied thereon for performing a method for providing targeted advertising content to a user in an automobile based on the location of the automobile, the method comprising:
locating an endpoint, wherein the endpoint is associated with the location of the automobile over a network;
receiving advertising content from the endpoint; and
providing the advertising content in the automobile.

2. The one or more computer storage media of claim 1, wherein the method further comprises receiving input from the user in response to the advertising content.

3. The one or more computer storage media of claim 2, wherein the input received from the user includes a voice input.

4. The one or more computer storage media of claim 1, wherein the advertising content comprises an audio advertisement.

5. The one or more computer storage media of claim 1, wherein the advertising content comprises a display advertisement.

6. The one or more computer storage media of claim 1, wherein the endpoint is associated with an entity, and the advertising content is associated with the entity.

7. The one or more computer storage media of claim 1, wherein the endpoint is associated with an entity, and the advertising content is not associated with the entity.

8. A computer system for providing targeted advertising to a user in an automobile with computer executable instructions embodied thereon, the system comprising:
a receiving component configured to receive advertising content from an endpoint; and
a presenting component configured to present the received advertising content.

9. The computer system of claim 8, further comprising a locating component configured to locate the endpoint.

10. The computer system of claim 8, further comprising an audio component configured to present the advertising content to the user, wherein the advertising content comprises an audio advertisement.

11. The computer system of claim 8, wherein the presenting component comprises a display device.

12. The computer system of claim 8, wherein the advertising content requires the user to provide input.

13. The computer system of claim 12, wherein the computer system further comprises a voice recognition component to receive the input from the user, wherein the input is voice input.

14. The computer system of claim 8, wherein the network comprises a blue-tooth network.

15. The computer system of claim 8, wherein the advertising content is associated with an entity that is associated with the endpoint.

16. One or more computer storage media having computer-executable instructions embodied thereon for performing a method for providing targeted advertising content to a user in an automobile based on the location of the automobile, wherein the automobile is connected to an endpoint over a network, the method comprising:
identifying the automobile over the network; and
sending advertising content from the endpoint to the automobile, wherein the endpoint is associated with the location of the automobile.

17. The one or more computer storage media of claim 16, wherein the automobile and the endpoint are connected over a blue-tooth network.

18. The one or more computer storage media of claim 16, wherein the advertising content is provided to the user in the automobile.

19. The one or more computer storage media of claim 16, wherein the advertising content comprises an audio advertisement.

20. The one or more computer storage media of claim 16, wherein the advertising content comprises a displayed advertisement.
